(19) United States
(12) Patent Application Publication
(10) Pub. No.: US 2010/0199782 A1
(43) Pub. Date: Aug. 12, 2010

(54) Torque-Angle Alarm Method and Wrench thereof

(75) Inventor: Chih-Ching HSIEH, TAICHUNG (TW)

Correspondence Address: BRIAN M. MCINNIS, 12th Floor, Ruttonjee House, 11 Duddell Street, Hong Kong, HK

(73) Assignee: Chih-Ching HSIEH, TAICHUNG (TW)

(21) Appl. No.: 12/366,652

(22) Filed: Feb. 6, 2009

(51) Int. Cl. G01L 5/24

(52) U.S. Cl. 73/862.23

(57) ABSTRACT

A wrench is disclosed. The wrench includes a body, a storing device, a torque sensing device, an angle sensing device and a processing device. The storing device stores a predetermined torque value and a predetermined angle value. The torque sensing device senses a torque provided by the body. The angle sensing device senses the rotation of the body after the torque reaches the predetermined torque value. The processing device generates an alarm signal while the rotation of the body reaches the predetermined angle value.

### BACKGROUND

1. Field of Invention

The present invention relates to a wrench. More particularly, the present invention relates to an electronic wrench.

2. Description of Related Art

FIG. 1A and FIG. 1B are the schematic views of a screw with a washer being driven into a tapped hole in the prior art. The washer 120 is arranged between the screw 110 and the tapped hole 130. Actually, the washer 120 is clipped by the nut of the screw 110 and the tapped hole 130. The washer 120 increases the frictional force under the contact surface of the tapped hole 130, and therefore prevents the screw 110 from loosening. The frictional force is determined by two factors, one is the friction coefficient of the washer 120, and the other is the downward force being applied under the washer 120. Generally speaking, the larger torque applied to the screw 110, the larger downward force being added under the washer 120. However, if the torque is too large, the surface of the washer 120 may be damaged when the nut rotationally engages the washer 120. Therefore, every pair of screw 110 and matched washer 120 in precision industry has their special requirements to define the suitable torque and rotation angle.

### SUMMARY

According to one embodiment of the invention, a wrench is disclosed. The wrench includes a body, a storing device, a torque sensing device, an angle sensing device and a processing device. The storing device stores a predetermined torque value and a predetermined angle value. The torque sensing device senses a torque provided by the body. The angle sensing device senses the rotation of the body after the torque reaches the predetermined torque value. The processing device generates an alarm signal while the rotation of the body reaches the predetermined angle value.

According to another embodiment of the invention, a torque-angle alarm method for a wrench is disclosed. The method includes the following steps:

setting a predetermined torque value and a predetermined angle value;

sensing a torque provided by the wrench;

triggering an angular velocity sensor after the torque reaches the predetermined torque value;

sensing the rotation of the wrench by the angular velocity sensor; and

raising an alarm after the rotation of the wrench reaches the predetermined angle value.

### BRIEF DESCRIPTION OF THE DRAWINGS

The invention can be more fully understood by reading the following detailed description of the embodiment, with reference made to the accompanying drawings as follows:

FIG. 1A and FIG. 1B are the schematic views of a screw with a washer being driven into a tapped hole in prior art.

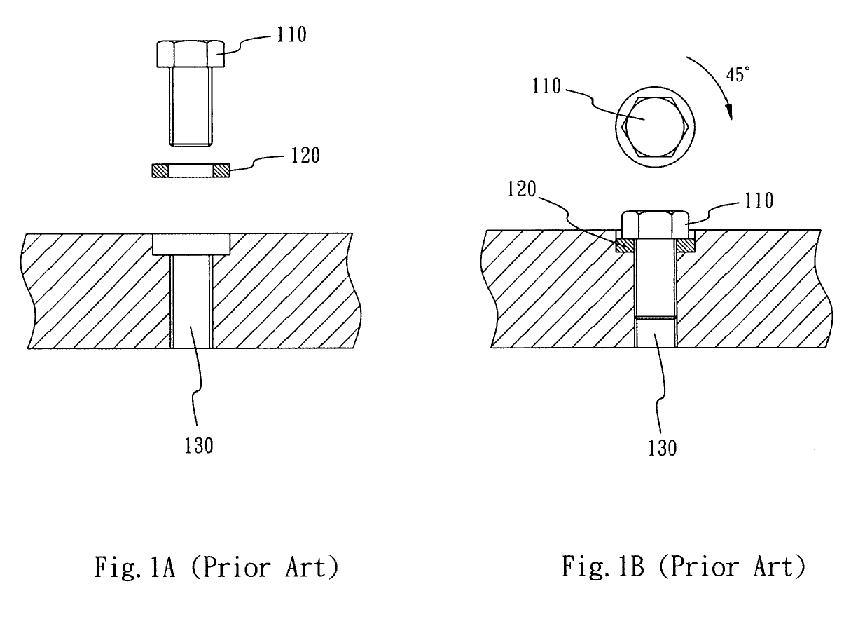

FIG. 2 is a schematic view of a wrench according to one embodiment of the present invention.

FIG. 3 is a functional block diagram of the electronic device of FIG. 2.

FIG. 4 is a detail functional block diagram of the electronic device of FIG. 2.

FIG. 5 is a circuit diagram of the torque sensing device of FIG. 4.

FIG. 6 is a circuit diagram of the angle sensing device of FIG. 4.

FIG. 7 is a circuit diagram of the processing device of FIG. 4.

FIG. 8 is a flowchart diagram of a torque-angle alarm method according to another embodiment of the present invention.

### DETAILED DESCRIPTION

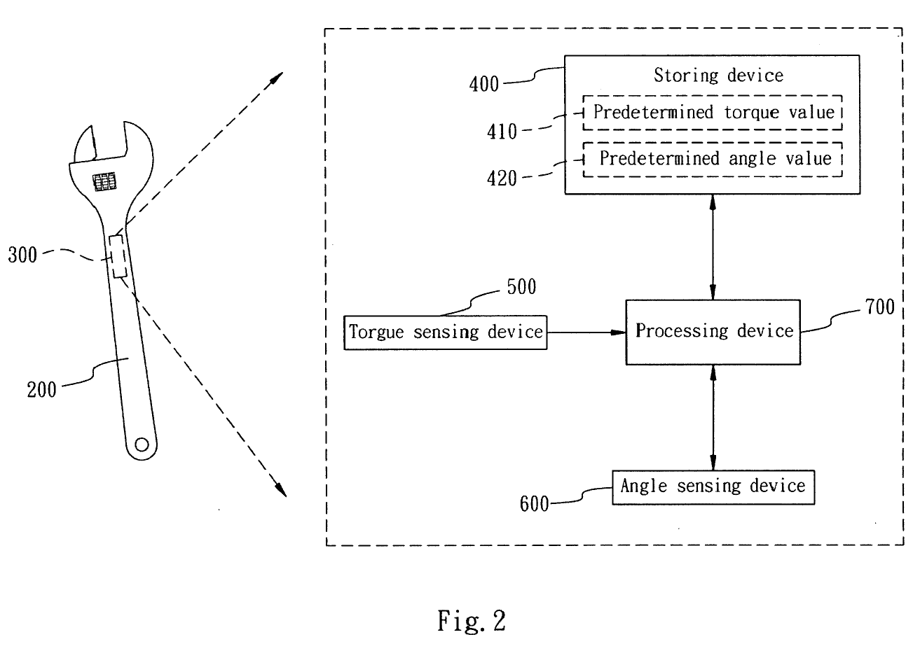

FIG. 2 is a schematic view of a wrench according to one embodiment of the present invention. The wrench includes a body 200 and an electronic device 300. The electronic device 300 is located in the body 200. The electronic device 300 includes a storing device 400, a torque sensing device 500, an angle sensing device 600 and a processing device 700. The storing device 400 stores a predetermined torque value 410 and a predetermined angle value 420. The torque sensing device 500 senses the torque provided by the body 200. The angle sensing device 600 also senses the rotation of the body 200 after the torque reaches the predetermined torque value 410. Finally, the processing device 700 generates an alarm signal 701 while the rotation of the body 200 reaches the predetermined angle value 420.

The predetermined torque value 410 and the predetermined angle value 420 are defined in the operation manual of precision industrial screws and washers. Therefore, the embodiment enables the user to preset the predetermined torque value 410 and the predetermined angle value 420 into the wrench. The wrench enables the user to conveniently drive the screw with the washer into the tapped hole in a suitable torque force. The wrench alerts the user when a suitable twist angle between the nut of the screw and the upper surface of the washer is reached.

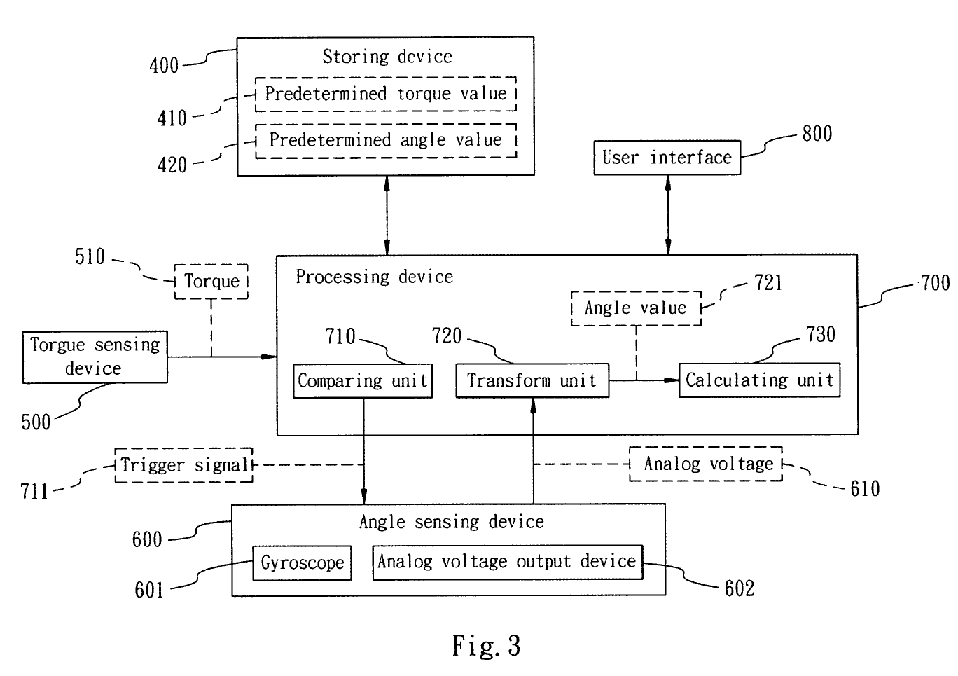

FIG. 3 is a functional block diagram of the electronic device 300 of FIG. 2. The torque sensing device 500 senses the torque 510 of the body 200, and further transmits a voltage signal that represents the torque 510 to the processing device 700. The angle sensing device 600 includes at least a gyroscope 601 and an analog voltage output device 602. The gyroscope 601 is applied to sense the rotation of the body 200, i.e. to detect the angular velocity of the body 200, and the analog voltage output device 602 provides an analog voltage 610 in accordance with the angular velocity of the body 200.

The processing device 700 includes a comparing unit 710, a transform unit 720 and a calculating unit 730. The comparing unit 710 triggers the gyroscope 601 while the torque 510 reaches the predetermined torque value 410. The comparing unit 710 sends out a trigger signal 711 to the angle sensing device 600 while the torque sensing device 500 senses that the torque 510 of the body 200 (in FIG. 2) reaches the predetermined torque value 410.

The analog voltage output device 602 sends the analog voltage 610 to the transform unit 720. The transform unit 720 transforms the analog voltage 610 into an angle value 721, and further transmits the angle value 721 to the calculating unit 730. The calculating unit 730 can be made by an accumulator. The calculating unit 730 accumulates the angle value 721 to generate a total angle value that represents the rotation of the body 200. In other words, the calculating unit 730 calculates the rotation of the body 200 by accumulating the angle value 721 after the torque 510 reaches the predetermined torque value 410.

In detail, the processing device 700 includes at least a microprocessor. The processing device 700 generates an alarm signal 701 when the total angle value reaches the predetermined angle value. The angle sensing device 600 is triggered to sense the rotation of the body 200 after receiving the trigger signal 711. The comparing unit 710 includes at least two input terminals. The processing device 700 generates a voltage level based on the predetermined torque value 410. The voltage level is feed to one input terminal of the comparing unit 710. The torque sensing device 500 senses the torque 510 provided by the body 200, and further outputs a voltage signal to represent the torque 510. The voltage signal is feed in the other input terminal of the comparing unit 710. Therefore, the comparing unit 710 can be made by a comparator to generate the trigger signal 711 once the voltage signal is larger than the voltage level.

Therefore, the wrench of the embodiment senses the torque 510 provided by the body 200. When the torque 510 reaches the requirement of the screw, the angle sensing device 600 is triggered by the trigger signal 711 of the comparing unit 710. And then, the angle sensing device 600 starts to sense the rotation angle of the body 200, i.e. the twist angle between the nut and the washer.

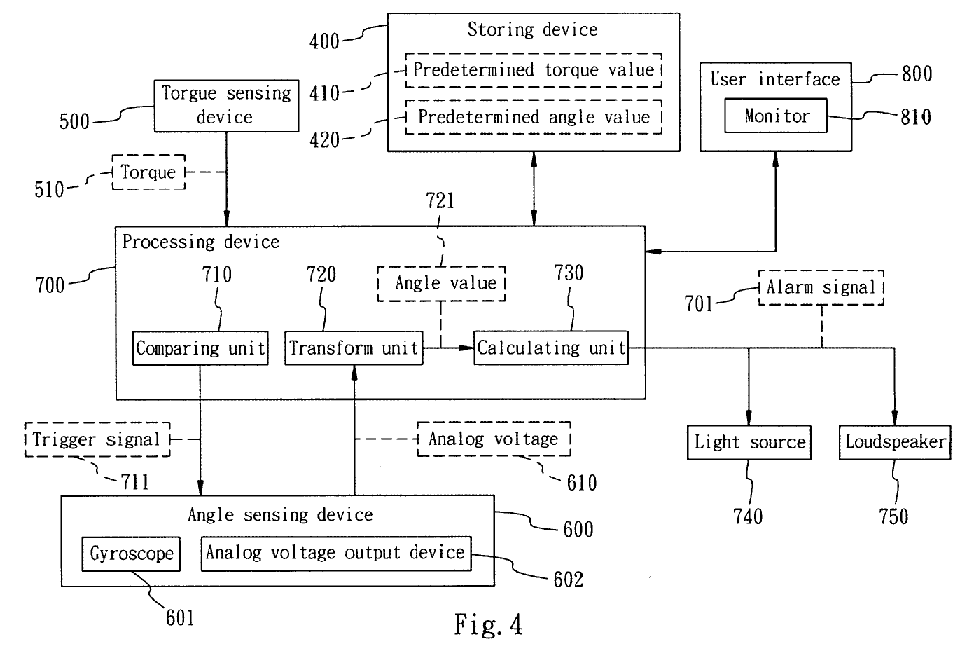

FIG. 4 is a detail functional block diagram of the electronic device 300 of FIG. 2. In FIG. 4, the electronic device 300 further includes a user interface 800. The user interface 800 is applied for a user to operate the electronic device 300 of the wrench. Generally speaking, the user interface 800 includes a universal serial bus (USB), a monitor 810 and an input device. The user can access the predetermined torque value 410 and the predetermined angle value 420 by the input device or the USB of the user interface 800. The user also can check the information such as the torque of the body, the angle of the body, the predetermined torque value 410 and the predetermined angle value 420 by the monitor 810. In addition, the electronic device 300 further includes a light source 740 and a loudspeaker 750. The light source 740 activates an alarm light in response to the alarm signal. The loudspeaker 750 activates an alarm sound in response to the alarm signal 701. Finally, the storing device 400 can be made by an electrically erasable programmable read only memory (EEPROM), a random access memory (RAM) or other equal devices.

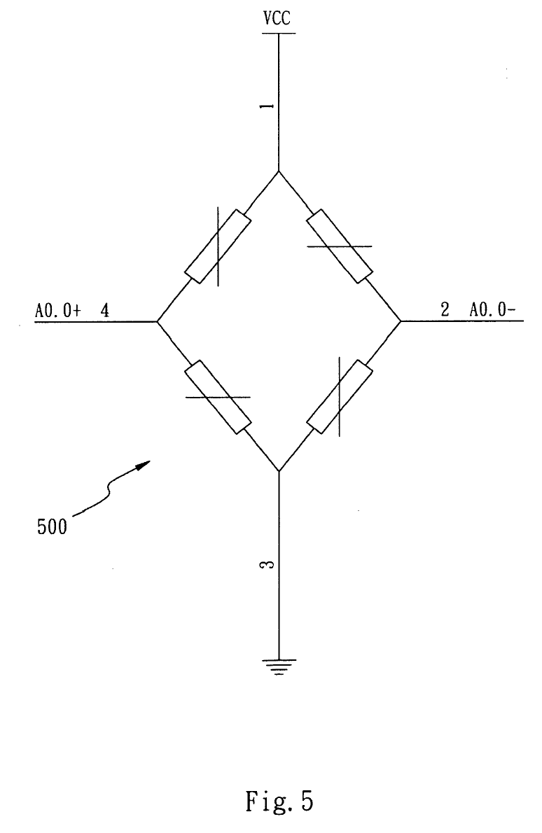

FIG. 5 is a circuit diagram of the torque sensing device 500 of FIG. 4. In FIG. 5, the torque sensing device 500 is achieved by the BKF350-1EB strain gauge of the DaJing Company. In detail, four BKF350-1EB strain gauges are arranged in a bridge circuit structure, and the bridge circuit structure includes two output terminals. One output terminal outputs a positive voltage that represents the clockwise torque of the body 200, and the other output terminal outputs a negative voltage that represents the counterclockwise torque of the body 200. The voltage differential value between the terminals represents the torque degree provided by the body 200.

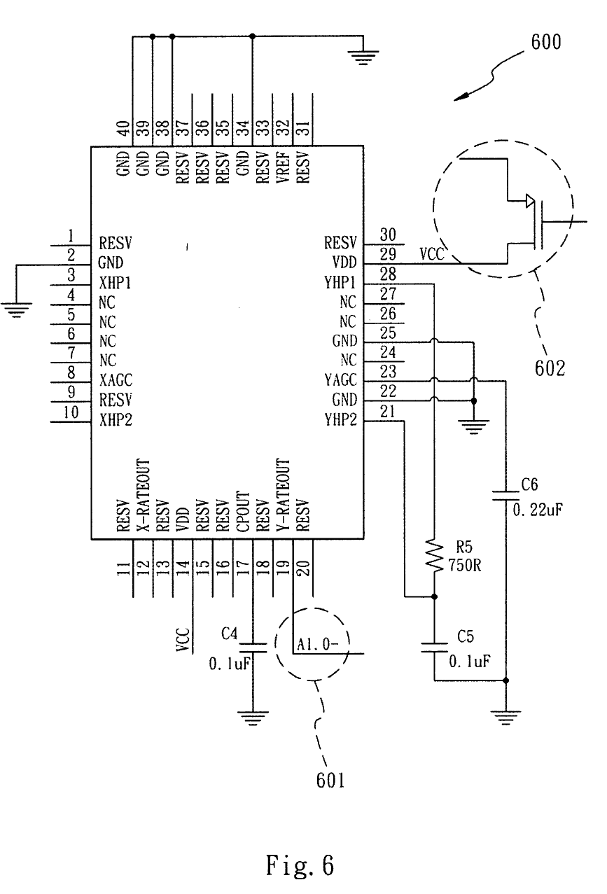

FIG. 6 is a circuit diagram of the angle sensing device 600 of FIG. 4. The angle sensing device 600 includes at least a gyroscope 601 and an analog voltage output device 602. The angle sensing device 600 can be achieved by the IDG-1004 gyroscope chip of the InvenSense Company. The IDG-1004 gyroscope chip outputs the analog voltage 610 to the processing device 700 via the output pin 601. The scale of the analog voltage 610 of the IDG-1004 gyroscope chip is 4 mV per degree in one second. The power of the IDG-1004 gyroscope chip is controlled by the switch 602. The gate of the switch 602 electrically connects the comparing unit 710 to receive the trigger signal 711.

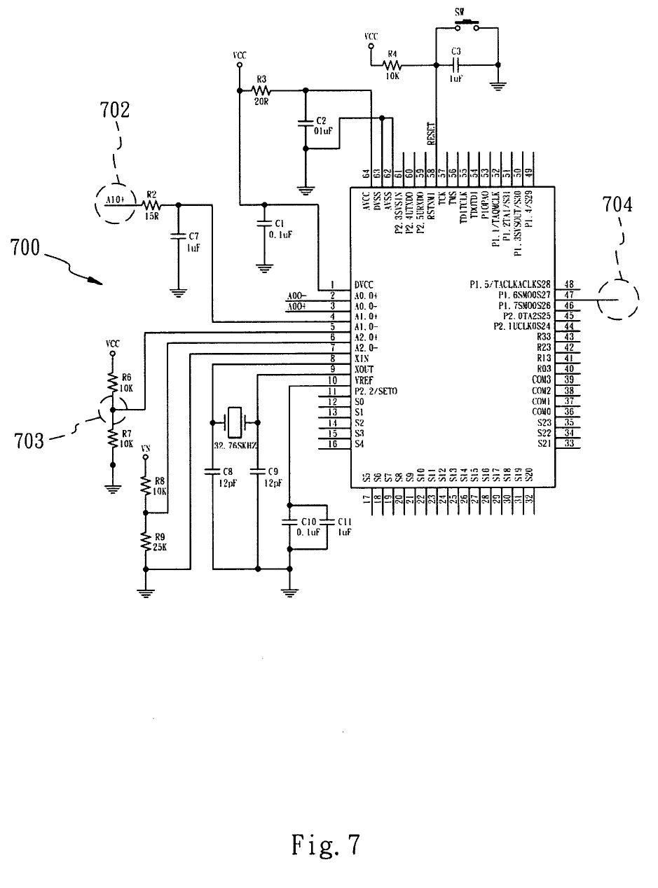

FIG. 7 is a circuit diagram of the processing device 700 of FIG. 4. The processing device 700 can be achieved by a microprocessor. In FIG. 7, the microprocessor is an MSP430-F427 single chip of the Texas Instruments Company. The MSP430-F427 single chip is applied with a peripheral circuit as shown in FIG. 7. In detail, the analog voltage 610 of the angle sensing device 600 is feed into the comparing unit 710 inside the MSP430-F427 single chip via the input terminal 702 of the peripheral circuit. The trigger signal 711 is provided to the angular velocity sensor 600 via the output pin 704. The MSP430-F427 single chip obtains a reference voltage via the voltage node 703, and generates the differential voltage of the reference voltage and the analog voltage 610. The transform unit 720 and the calculating unit 730 use the differential voltage and a time period signal to calculate the rotation angle of the body 200. Wherein, the time period signal is provided by an oscillator of the MSP430-F427 single chip.

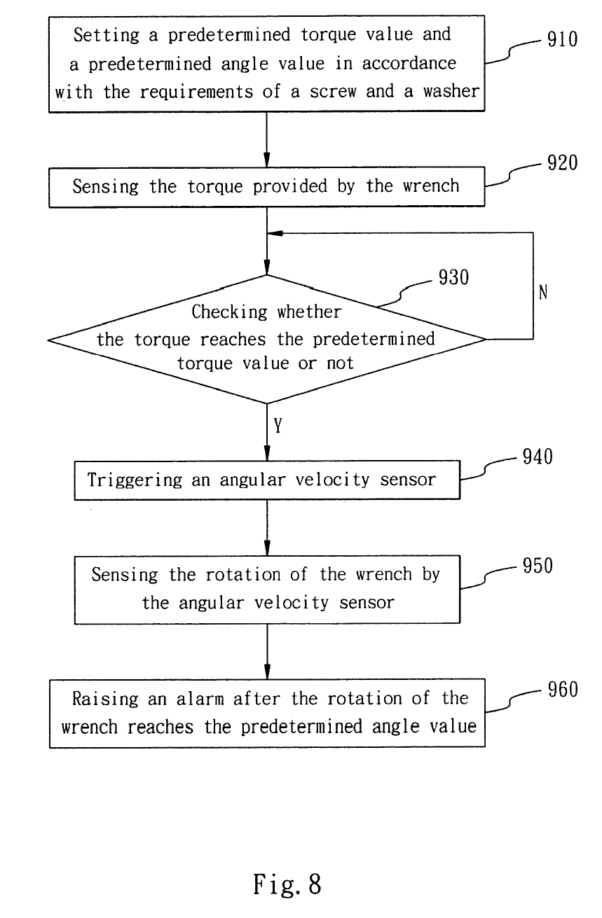

FIG. 8 is a flowchart diagram of a torque-angle alarm method according to another embodiment of the present invention. The embodiment includes the following steps: First, as shown in step 910, a predetermined torque value and a predetermined angle value are set in accordance with the requirements of the screw and the washer. And then, as shown in step 920, a torque is provided by the wrench. And then, as shown in step 930, a comparator is applied to check whether the torque reaches the predetermined torque value or not. If yes, as shown in step 940, an angle sensing device is triggered after the torque reaches the predetermined torque value. And then, as shown in step 950, the angle sensing device is applied to sense the rotation of the wrench. Finally, as shown in step 960, an alarm is raised after the rotation of the wrench reaches to the predetermined angle value.

While the present invention has been described by way of example and in terms of a preferred embodiment, it is to be understood that the present invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wrench comprising:
a body;
means for storing a predetermined torque value and a predetermined angle value;
means for sensing a torque provided by the body;
means for sensing the rotation of the body after the torque reaches the predetermined torque value; and
means for generating an alarm signal while the rotation of the body reaches the predetermined angle value.

2. The wrench of claim 1, wherein the means for sensing the rotation of the body comprises:
a gyroscope for detecting the angular velocity of the body; and
an analog voltage output device for providing an analog voltage according to the angular velocity of the body.

3. The wrench of claim 2, further comprising:
means for triggering the gyroscope while the torque reaches the predetermined torque value.

4. The wrench of claim 2, wherein the means for generating the alarm signal comprises:
a transforming unit for transforming the analog voltage into an angle value.

5. The wrench of claim 4, wherein the means for generating the alarm signal comprises:
a calculating unit for calculating the rotation of the body by accumulating the angle value after the torque reaches the predetermined torque value.

6. The wrench of claim 1, wherein the means for sensing the torque comprises at least one strain gauge.

7. The wrench of claim 1, further comprising:
a user interface for accessing the predetermined torque value and the predetermined angle value.

8. The wrench of claim 7, wherein the user interface comprises a is monitor.

9. The wrench of claim 1, further comprising:
a light source for activating an alarm light in response to the alarm signal.

10. The wrench of claim 1, further comprising:
a loudspeaker for activating an alarm sound in response to the alarm signal.

11. The wrench of claim 1, wherein the means for storing the predetermined torque value and the predetermined angle value comprises at least an electrically erasable programmable read only memory (EEPROM).

12. The wrench of claim 1, wherein the means for generating the alarm signal comprises a microprocessor.

13. A torque-angle alarm method for a wrench, the torque-angle alarm method comprising:
setting a predetermined torque value and a predetermined angle value;
sensing a torque provided by the wrench;
triggering an angular velocity sensor after the torque reaches the predetermined torque value;
sensing the rotation of the wrench by the angular velocity sensor; and
raising an alarm after the rotation of the wrench reaches the predetermined angle value.

14. The torque-angle alarm method of claim 13, further comprising:
accessing the predetermined torque value by a universal serial bus (USB).

15. The torque-angle alarm method of claim 13, further comprising:
accessing the predetermined angle value by a universal serial bus (USB).

16. The torque-angle alarm method of claim 13, wherein raising the alarm comprises:
activating an alarm light by a light source.

17. The torque-angle alarm method of claim 13, wherein raising the alarm comprises:
activating an alarm sound by a loudspeaker.

18. The torque-angle alarm method of claim 13, wherein setting the predetermined torque value and the predetermined angle value comprises:
storing the predetermined torque value and the predetermined angle value in an electrically erasable programmable read only memory (EEPROM).
